(19) United States
(12) Patent Application Publication
(10) Pub. No.: US 2025/0386307 A1
(43) Pub. Date: Dec. 18, 2025

(54) ARTIFICIAL INTELLIGENCE-ENABLED MEDIUM ACCESS CONTROL DELAY STATUS REPORTING

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US)

(21) Appl. No.: 18/745,621

(22) Filed: Jun. 17, 2024

(51) Int. Cl. H04W 56/00; H04W 48/16; H04W 72/0453

(52) U.S. Cl. CPC H04W 56/001; H04W 48/16; H04W 72/0453

(57) ABSTRACT

Methods, systems, and devices for wireless communication are described. A wireless device may receive a configuration including a first set of one or more parameters associated with delay status reporting (DSR) for each of one or more logical channels (LCHs) of a group of LCHs associated with a medium access control (MAC) entity of the wireless device. At least one parameter of the first set of one or more parameters is associated with a plurality of values. The wireless device may select a value of the plurality of values for a timer associated with the DSR based at least in part on a second set of one or more parameters, and process one or more service data units (SDUs) for each of one or more LCHs of the group of LCHs according to the selected value for the timer associated with the DSR.

### FIELD OF TECHNOLOGY

The following relates to wireless communication, including artificial intelligence (AI)-enabled medium access control (MAC) delay status reporting (DSR).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include receiving control signaling that indicates a configuration including a first set of one or more parameters associated with delay status reporting (DSR) for each of one or more logical channels (LCH) of a group of LCHs associated with a medium access control (MAC) entity of the wireless device, where at least one parameter of the first set of one or more parameters is associated with a set of multiple values, selecting a value of the set of multiple values for a timer associated with the DSR for each of one or more LCHs of the group of LCHs based on a second set of one or more parameters, and processing one or more service data units (SDUs) for each of one or more LCHs of the group of LCHs according to the selected value of the set of multiple values for the timer associated with the DSR.

A wireless device for wireless communications is described. The wireless device may include one or more memories storing processor executable code, and one or more processors coupled with the one or more memories. The one or more processors may individually or collectively be operable to execute the code to cause the wireless device to receive control signaling that indicates a configuration including a first set of one or more parameters associated with DSR for each of one or more LCHs of a group of LCHs associated with a MAC entity of the wireless device, where at least one parameter of the first set of one or more parameters is associated with a set of multiple values, select a value of the set of multiple values for a timer associated with the DSR for each of one or more LCHs of the group of LCHs based on a second set of one or more parameters, and process one or more SDUs for each of one or more LCHs of the group of LCHs according to the selected value of the set of multiple values for the timer associated with the DSR.

Another wireless device for wireless communications is described. The wireless device may include means for receiving control signaling that indicates a configuration including a first set of one or more parameters associated with DSR for each of one or more LCHs of a group of LCHs associated with a MAC entity of the wireless device, where at least one parameter of the first set of one or more parameters is associated with a set of multiple values, means for selecting a value of the set of multiple values for a timer associated with the DSR for each of one or more LCHs of the group of LCHs based on a second set of one or more parameters, and means for processing one or more SDUs for each of one or more LCHs of the group of LCHs according to the selected value of the set of multiple values for the timer associated with the DSR.

A non-transitory computer-readable medium storing code for wireless communications is described. The code may include instructions executable by one or more processors to receive control signaling that indicates a configuration including a first set of one or more parameters associated with DSR for each of one or more LCHs of a group of LCHs associated with a MAC entity of the wireless device, where at least one parameter of the first set of one or more parameters is associated with a set of multiple values, select a value of the set of multiple values for a timer associated with the DSR for each of one or more LCHs of the group of LCHs based on a second set of one or more parameters, and process one or more SDUs for each of one or more LCHs of the group of LCHs according to the selected value of the set of multiple values for the timer associated with the DSR.

In some examples of the method, wireless devices, and non-transitory computer-readable medium described herein, the first set of one or more parameters includes an input to a learning model associated with the DSR for each of one or more LCHs of the group of LCHs associated with the MAC entity, the second set of one or more parameters includes an output of the learning model associated with the DSR for each of one or more LCHs of the group of LCHs associated with the MAC entity, and selecting the value of the set of multiple values for the timer associated with the DSR may be based on the input to the learning model and the output of the learning model.

In some examples of the method, wireless devices, and non-transitory computer-readable medium described herein, at least one parameter of the first set of one or more parameters includes an indication to enable or disable a learning model associated with the DSR for each of one or more LCHs of the group of LCHs.

In some examples of the method, wireless devices, and non-transitory computer-readable medium described herein, one or more parameters of the first set of one or more parameters includes a lower boundary value for the timer associated with the DSR for each of one or more LCHs of the group of LCHs or an upper boundary value for the timer associated with the DSR for each of one or more LCHs of the group of LCHs and the one or more parameters of the first set of one or more parameters includes a range of values for the timer associated with the DSR for each of one or more LCHs of the group of LCHs.

In some examples of the method, wireless devices, and non-transitory computer-readable medium described herein, one or more parameters of the first set of one or more parameters includes a first indication that the MAC entity may be allowed to override a default value for the timer associated with the DSR for each of one or more LCHs of the group of LCHs, a second indication that the MAC entity may be prohibited to override the default value for the timer associated with the DSR for each of one or more LCHs of the group of LCHs, or a second indication that the MAC entity may be allowed to override the default value of the timer associated with the DSR for each of one or more LCHs of the group of LCHs based on a condition.

Some examples of the method, wireless devices, and non-transitory computer-readable medium described herein may further include operations, features, means, or instructions for transmitting an indication of the selected value of the set of multiple values for the timer associated with the DSR for each of one or more LCHs of the group of LCHs, where the indication includes a medium access control-control element (MAC-CE) or an uplink control information (UCI).

Some examples of the method, wireless devices, and non-transitory computer-readable medium described herein may further include operations, features, means, or instructions for transmitting the indication of the selected value of the set of multiple values for the timer associated with the DSR for each of one or more LCHs of the group of LCHs may be based on a periodicity or a condition.

Some examples of the method, wireless devices, and non-transitory computer-readable medium described herein may further include operations, features, means, or instructions for transmitting the indication of the selected value of the set of multiple values for the timer associated with the DSR for each of one or more LCHs of the group of LCHs may be based on a prohibit timer.

In some examples of the method, wireless devices, and non-transitory computer-readable medium described herein, the configuration includes a radio resource control (RRC) configuration.

Some examples of the method, wireless devices, and non-transitory computer-readable medium described herein may further include operations, features, means, or instructions for receiving second control signaling that indicates a LCH identifier, where the LCH identifier maps to one or more LCHs of the group of LCHs associated with the MAC entity, where the second control signaling further indicates the value of the set of multiple values for the timer associated with the DSR for each of one or more LCHs of the group of LCHs, where the second control signaling includes a MAC-CE or downlink control information (DCI), and where selecting the value of the set of multiple values for the timer associated with the DSR may be based on the received second control signaling.

Some examples of the method, wireless devices, and non-transitory computer-readable medium described herein may further include operations, features, means, or instructions for transmitting a hybrid automatic repeat request (HARQ) acknowledgment based on the received second control signaling.

Some examples of the method, wireless devices, and non-transitory computer-readable medium described herein may further include operations, features, means, or instructions for generating a report associated with a learning model, where the report includes a set of one or more logs associated with processing of the one or more SDUs according to the learning model and one or more selected values of the set of multiple values for the timer associated with the DSR for each of one or more LCHs of the group of LCHs and transmitting the report associated with the learning model to a network entity or a second wireless device.

In some examples of the method, wireless devices, and non-transitory computer-readable medium described herein, the report may be based on a reporting configuration, an event-based reporting trigger, or a prohibit timer.

Some examples of the method, wireless devices, and non-transitory computer-readable medium described herein may further include operations, features, means, or instructions for transmitting, to a network entity or a second wireless device, a report including capability information that indicates whether the wireless device supports a learning model associated with the DSR for each of one or more LCHs of the group of LCHs associated with the MAC entity, where the capability information further indicates whether the wireless device supports performance reporting for the learning model associated with the DSR for each of one or more LCHs of the group of LCHs associated with the MAC entity, where the control signaling that indicates the configuration may be received based on the capability information.

In some examples of the method, wireless devices, and non-transitory computer-readable medium described herein, at least one parameter of the first set of one or more parameters includes a minimum value for the timer associated with the DSR for each of one or more LCHs of the group of LCHs.

In some examples of the method, wireless devices, and non-transitory computer-readable medium described herein, at least one parameter of the first set of one or more parameters includes a maximum value for the timer associated with the DSR for each of one or more LCHs of the group of LCHs.

In some examples of the method, wireless devices, and non-transitory computer-readable medium described herein, at least one parameter of the first set of one or more parameters includes an indication to override a current value of the timer associated with the DSR for each of one or more LCHs of the group of LCHs by the selected value.

In some examples of the method, wireless devices, and non-transitory computer-readable medium described herein, at least one parameter of the first set of one or more parameters includes an indication of a threshold value to be satisfied prior to an override of a current value of the timer associated with the DSR for each of one or more LCHs of the group of LCHs by the selected value.

In some examples of the method, wireless devices, and non-transitory computer-readable medium described herein, at least one parameter of the first set of one or more parameters includes an indication for reporting of the timer associated with the DSR for each of one or more LCHs of the group of LCHs.

In some examples of the method, wireless devices, and non-transitory computer-readable medium described herein, at least one parameter of the first set of one or more parameters includes a duration for periodic reporting of the timer associated with the DSR for each of one or more LCHs of the group of LCHs.

In some examples of the method, wireless devices, and non-transitory computer-readable medium described herein, at least one parameter of the first set of one or more parameters includes a duration for event-based reporting of the timer associated with the DSR for each of one or more LCHs of the group of LCHs.

A method for wireless communications by a network entity is described. The method may include transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values and receiving one or more SDUs for each of one or more LCHs of the group of LCHs.

A network entity for wireless communications is described. The network entity may include one or more memories storing processor executable code, and one or more processors coupled with the one or more memories. The one or more processors may individually or collectively be operable to execute the code to cause the network entity to transmit control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values and receive one or more SDUs for each of one or more LCHs of the group of LCHs.

Another network entity for wireless communications is described. The network entity may include means for transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values and means for receiving one or more SDUs for each of one or more LCHs of the group of LCHs.

A non-transitory computer-readable medium storing code for wireless communications is described. The code may include instructions executable by one or more processors to transmit control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values and receive one or more SDUs for each of one or more LCHs of the group of LCHs.

In some examples of the method, network entities, and non-transitory computer-readable medium described herein, at least one parameter of the first set of one or more parameters includes an indication to enable or disable a learning model associated with the DSR for each of one or more LCHs of the group of LCHs.

Some examples of the method, network entities, and non-transitory computer-readable medium described herein may further include operations, features, means, or instructions for receiving an indication of a selected value of a set of multiple values for a timer associated with the DSR for each of one or more LCHs of the group of LCHs, where the indication includes a MAC-CE or UCI.

In some examples of the method, network entities, and non-transitory computer-readable medium described herein, the configuration includes an RRC configuration.

Some examples of the method, network entities, and non-transitory computer-readable medium described herein may further include operations, features, means, or instructions for transmitting second control signaling that indicates a LCH identifier, where the LCH identifier maps to one or more LCHs of the group of LCHs associated with the MAC entity, where the second control signaling further indicates a value of a set of multiple values for a timer associated with the DSR for each of one or more LCHs of the group of LCHs, and where the second control signaling includes MAC-CE or DCI.

Some examples of the method, network entities, and non-transitory computer-readable medium described herein may further include operations, features, means, or instructions for receiving HARQ acknowledgment based on the transmitted second control signaling.

Some examples of the method, network entities, and non-transitory computer-readable medium described herein may further include operations, features, means, or instructions for receiving a report associated with a learning model, where the report may be based on a reporting configuration, an event-based reporting trigger, or a prohibit timer.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show example of wireless communications systems that support artificial intelligence (AI)-enabled medium access control (MAC) delay status reporting (DSR) in accordance with one or more aspects of the present disclosure.

FIG. 3 shows an example of a machine learning (ML) architecture that supports AI-enabled MAC DSR in accordance with one or more aspects of the present disclosure.

FIG. 4 shows an example of a process flow that supports AI-enabled MAC DSR in accordance with one or more aspects of the present disclosure.

FIGS. 5 and 6 show block diagrams of devices that support AI-enabled MAC DSR in accordance with one or more aspects of the present disclosure.

FIG. 7 shows a block diagram of a communications manager that supports AI-enabled MAC DSR in accordance with one or more aspects of the present disclosure.

FIG. 8 shows a diagram of a system including a device that supports AI-enabled MAC DSR in accordance with one or more aspects of the present disclosure.

FIGS. 9 and 10 show block diagrams of devices that support AI-enabled MAC DSR in accordance with one or more aspects of the present disclosure.

FIG. 11 shows a block diagram of a communications manager that supports AI-enabled MAC DSR in accordance with one or more aspects of the present disclosure.

FIG. 12 shows a diagram of a system including a device that supports AI-enabled MAC DSR in accordance with one or more aspects of the present disclosure.

FIGS. 13 and 14 show flowcharts illustrating methods that support AI-enabled MAC DSR in accordance with one or more aspects of the present disclosure.

### DETAILED DESCRIPTION

A wireless device may support various radio access technologies, such as 5G, which provide high-speed, low-latency, and high-reliability connectivity. Consequently, the wireless device may support latency-sensitive applications and services, including immersive extended reality (XR) multimedia, cloud computing, augmented reality (AR) glasses, virtual reality (VR) head-mounted displays (HMD), cloud gaming, and cloud-based AI. These applications and services might often require specific data rate, latency, and power consumption parameters. For instance, XR-related applications may impose that 99% of XR traffic packets be delivered within a defined packet delay budget (PDB) (such as 10 milliseconds (ms)). To address these low latency requirements, the wireless device may support providing a delay status report (DSR).

The DSR may be a DSR medium access control-control element (MAC-CE) which indicates a delay status for one or more logical channel (LCH) groups (LCGs). The delay status may indicate a value of a discard timer (e.g., a PDCP discard timer) associated with the wireless device and an service data unit (SDU) buffered for the LCG. The discard timer, such as the PDCP discard timer is a timer that manages how long a protocol entity (e.g., a PDCP entity) of the wireless device retains (e.g., stores, buffers) an SDU before discarding the SDU. For instance, the delay status may indicate a smallest remaining value of the discard timer for a corresponding SDU. The wireless device may receive a configuration, including parameters related to DSR. This configuration may be an RRC configuration, including an LCG identifier and a value of a remaining time threshold associated with the discard timer for the LCG. The wireless device may trigger DSR based on a value of the discard timer being less than or equal to the remaining time threshold.

A network entity, such as a base station may set the remaining time threshold based on quality of service (QOS) requirements, such as a PDB or a PDU set delay budget (PSDB), or based on a resource allocation (e.g., an uplink grant) for the wireless device. In some cases, if the value of the remaining time threshold is set too low, the base station might not have enough time to transmit the grant before the discard timer expires. In some other cases, if the value of the remaining time threshold is set too high, it may lead to inefficient resource allocation. Additionally, if the wireless device has higher priority data waiting, the wireless device may not transmit data for the LCH as expected, causing delays and potential expiration of the discard timer, thus impacting user experience.

According to various aspects of the present disclosure, the wireless device may support AI-enabled DSR. The wireless device can determine QoS requirements for corresponding QoS flows and the data (e.g., SDUs) stored in buffers of the wireless device. Based on these factors, the wireless device may select a value of a remaining time threshold for a discard timer using a learning model (e.g., an AI/ML model). For example, the wireless device may identify the amount of data awaiting transmission for each LCH and measure the average time an SDU remains in a corresponding buffer before being transmitted. The wireless device may use this information (e.g., a number of SDUs and the average time an SDU remains in a corresponding buffer) to trigger DSR, ensuring SDUs are transmitted before their discard timers expire.

The wireless device may update a current value of the remaining time threshold based on the learning model, overriding default or previously configured values set by network entities or the base station. The wireless device may report the selected value to the network entities or the base station, which may reconfigure the wireless device accordingly. Thus, the wireless device may improve use of the remaining time threshold based on the AI/ML model within the configuration parameters set by the network entities or the base station. It should be understood that other models or data structures (e.g., tables) may be used for supporting and enabling the wireless device to support AI-enabled DSR as described herein.

Aspects of the disclosure are initially described in the context of wireless communications systems. Aspects of the disclosure are further illustrated by and described with reference to apparatus diagrams, system diagrams, and flowcharts that relate to AI-enabled MAC DSR.

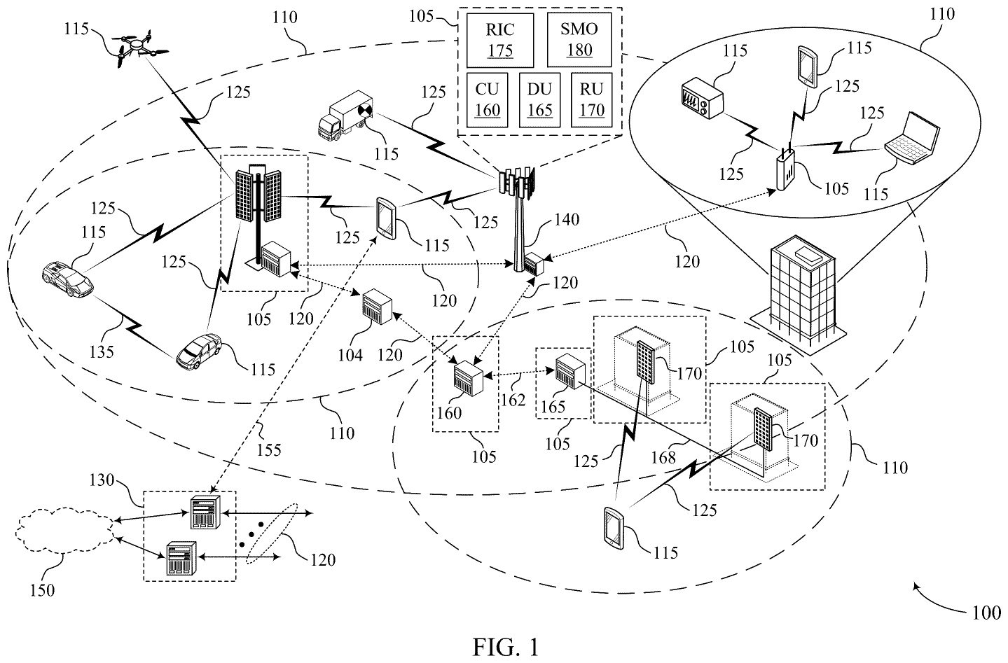

FIG. 1 shows an example of a wireless communications system 100 that supports AI-enabled MAC DSR in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communication system 100 may support various radio access technologies, such as 5G, which may provide high-speed, low-latency, and high-reliability connectivity. As a result, the wireless communication system 100 may support latency-sensitive applications and/or services such as immersive extended reality (XR) multimedia and cloud computing. Other examples of such services and/or applications include augmented reality (AR) glasses, virtual reality (VR) head-mounted displays (HMD), cloud gaming, and cloud-based AI. These services and/or applications may be associated with certain requirements, such as data rate, latency, and power consumption. For example, XR-related applications may require that a threshold number of XR traffic packets (e.g., 99%) be delivered within a packet delay budget (PDB), which may be, for example, 10 milliseconds. To address the low latency requirements of certain services and/or applications, the wireless communication system 100 may support DSR.

In the wireless communications system 100, a UE 115 may transmit, and a base station 140 (e.g., a serving base station) may receive, a DSR. In some examples, the DSR may be a DSR MAC-CE. The DSR may indicate a delay status associated with one or more LCH groups (LCGs). The delay status for an LCG may indicate a value of a discard timer (also referred to as a “PDCP discard timer”) associated with the UE 115 and associated with an SDU buffered for the LCG. For example, a delay status may indicate a smallest remaining value associated with a corresponding discard timer and associated with a corresponding SDU buffered for a corresponding LCG. Additionally, or alternatively, the delay status for an LCG may indicate a total quantity (e.g., number) of data for the LCG. For example, a delay status for an LCG may indicate a total quantity of low latency (e.g., delay-critical) uplink data for the LCG.

The base station 140 may transmit to the UE 115 a configuration, which may include one or more parameters associated with DSR. For example, the base station 140 may transmit to the UE 115 an RRC configuration (e.g., an LCG-DSR-Config), which may include an identifier of an LCG (e.g., lcg-Id) for which the configuration is applicable and a value of a remaining time threshold for the LCG. The remaining time threshold may be a static parameter configured by the RRC configuration. In some examples, the UE 115 may trigger DSR in response to a value of a discard timer (e.g., a PDCP discard timer) being less than or equal to the value of the remaining time threshold. In some other examples, the UE 115 may trigger DSR in response to a smallest remaining value of a corresponding discard timer (e.g., a PDCP discard timer) associated with one more SDUs buffered for an LCG being below the value of the remaining time threshold.

The base station 140 may determine (e.g., configure, set) the value for the remaining time threshold based on one or more quality of service (QOS) requirements, such as a PDB and/or a PDU set delay budget (PSDB). In other examples, the base station 140 may determine (e.g., configure, set) the value for the remaining time threshold based on a resource allocation (e.g., an uplink grant) for the UE 115. For example, the base station 140 may determine (e.g., configure, set) the value for the remaining time threshold based on uplink resources the base station 140 allocates (e.g., grants) to the UE 115, so that one or more SDUs may be delivered (e.g., transmitted) before the discard timer expires (e.g., lapses).

By way of example, at a first time (e.g., T₀), a buffer of a UE 115 for a first LCH (e.g., LCH₀) may be empty. At a second time (e.g., T₁), the UE 115 may obtain (e.g., receive) an SDU at the buffer of the UE 115 for the first LCH (e.g., LCH₀). The UE 115 may trigger a buffer status report (BSR) and start a discard timer (e.g., a PDCP discard timer). At a third time (e.g., T₂), in response to the BSR, a base station 140 may transmit to the UE 115 a grant (e.g., an uplink grant) that includes a resource allocation (e.g., one or more uplink resources). Based at least in part on the received grant, the UE 115 may transmit the SDU (e.g., data associated with the SDU). At a fourth time (e.g., T₃), the UE 115 may determine that a remaining value of the discard timer falls below a value of a remaining time threshold. As a result, the UE 115 may trigger DSR. At a fifth time (e.g., T₄), the UE 115 may complete transmission of the SDU before the discard timer expires.

In some cases, the set value for the remaining time threshold may be inadequate (e.g., inefficient). For example, if the value for the remaining time threshold is too low, the base station 140 may have insufficient time to transmit the grant (e.g., the uplink grant) to the UE 115, so that the UE 115 can complete transmission of an SDU before the discard timer expires. Alternatively, if the value for the remaining time threshold is too high, the base station 140 may allocate too many resources to the UE 115, which may result in unused resources (e.g., resources not used by the UE 115).

In some cases, when the base station 140 receives a DSR for an LCH from the UE 115, the UE 115 may have higher priority data waiting for transmission and may be unable to transmit data for the LCH (e.g., as often as expected) based on the set value for the remaining time threshold. Additionally, in some cases, when the base station 140 configures the discard timer, the base station 140 may be unable to determine (e.g., may be unaware) how often (e.g., based on a traffic load) and how many (e.g., traffic load, radio conditions) uplink resources to grant to the UE 115 upon reception of the DSR. In both cases, transmissions of one or more SDUs by the UE 115 is delayed and the discard timer may expire thereby impacting a user experience (e.g., extended latency associated with an application and/or service associated with the one or more SDUs).

The wireless communications system 100, including one or more network entities 105, one or more UEs 115, and one or more base stations may support AI-enabled DSR. A UE 115 may determine (e.g., be aware of) one or more QoS requirements of one or more corresponding QoS flows. Additionally, or alternatively, the UE 115 may determine (e.g., be aware of) data (e.g., SDUs, PDUs) stored in one more buffers of the UE 115. As such, the UE 115 may, based on one or more of the QoS requirements of one or more corresponding QoS flows and data stored in the one more buffers, select a value for a remaining time threshold associated with a discard timer according to a learning model (e.g., an AI/ML model).

In some cases, the UE 115 may be aware of (e.g., determine, identify) an accurate amount of data awaiting transmission for each of LCH. In some other cases, the UE 115 may be measure and determine an average time that an SDU remains in a buffer of the UE 115 before being successfully delivered (e.g., transmitted) to the base station 140. In both cases, the UE 115 may determine when to trigger DSR to ensure that corresponding SDUs are transmitted before corresponding discard timers expire.

The UE 115 may update (e.g., override) a current value (e.g., a default value or a previously configured value by one or more of a network entity 105 or a base station 140) for the remaining time threshold associated with the discard timer with the selected value according to the learning model. Additionally, the UE 115 may report the selected value to one or more of the network entity 105 or the base station 140, which may reconfigure the UE 115 accordingly. Thus, the UE may perform selection of the value for the remaining time threshold based on the learning model (e.g., the AI/ML model) in accordance with a configuration allowed (e.g., configured) by the base station 140.

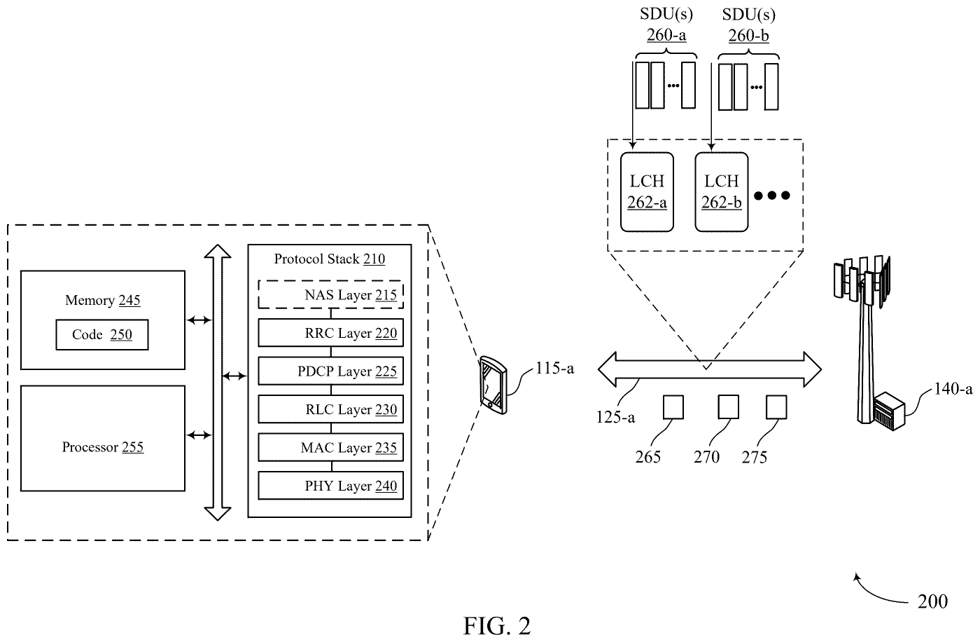

FIG. 2 shows an example of a wireless communications system 200 that supports AI-enabled MAC DSR in accordance with one or more aspects of the present disclosure. In some examples, the wireless communications system 200 may implement or be implemented by aspects of the wireless communications system 100 as described herein with reference to FIG. 1. For example, the wireless communications system 200 may include a UE 115-a and a base station 140-a, which may be an example of UEs 115 and base stations 140 as described herein with reference to FIG. 1. The wireless communications system 200 may support 5G or radio access technologies beyond 5G.

The UE 115-a and the base station 140-a may perform wireless communication (e.g., one or more of receiving, obtaining, transmitting, or outputting one or more of control information or data) via a communication link 125-a, which may be examples of communications links 125 as described herein with reference to FIG. 1. In the example of FIG. 2, the UE 115-a may be equipped (e.g., configured) with at least one protocol stack 210 to support one or more of receiving, obtaining, transmitting, or outputting control information or data information, or any combination thereof (e.g., PDUs, SDUs) associated with various channels (e.g., control channels, data channels, logical channels). The at least one protocol stack 210 may include one or more protocol layers, which may be ordered in a hierarchical architecture. In some examples, the at least one protocol stack 210 may be associated with one or more of a control plane (and may be referred to as a control plane protocol stack) or a user plane (and may be referred to as a user plane protocol stack). The at least one protocol stack 210 may include one or more of a NAS layer 215, an RRC layer 220, a PDCP layer 225, an RLC layer 230, a MAC layer 235, or a PHY layer 240.

The NAS layer 215 may be capable of, configured to, or operable to support mobility, authentication, and bearer management for the UE 115-a served by the base station 140-a. The RRC layer 220 may be capable of, configured to, or operable to support establishment, configuration, and maintenance of a connection between the UE 115-a and the base station 140-a supporting radio bearers for user plane data. Additionally, the RRC layer 220 may be capable of, configured to, or operable to support establishment, configuration, and maintenance of a connection between a network entity 105 or a core network 130 supporting radio bearers for user plane data as described herein with reference to FIG. 1. The PDCP layer 225 may be capable of, configured to, or operable to support header compression, in-sequence delivery, ciphering and integrity protection, transfer of user plane and control plane data, removal of duplicates. Additionally, or alternatively, PDCP layer 225 may be capable of, configured to, or operable to support routing of control information or data information, or any combination thereof (e.g., PDUs, SDUs) over split barriers.

The RLC layer 230 may be capable of, configured to, or operable to support transfer of upper layer PDUs. The RLC layer 230 may perform error correction through ARQ, concatenation, segmentation, and reassembly of RLC SDUs, re-segmentation of RLC data PDUs, reordering of RLC data PDUs, duplicate detection, RLC re-establishment and protocol error detection and recovery. The RLC layer 230 of the UE 115-a may receive RLC SDU from and/or transmit to upper protocol layers (e.g., the PDCP layer 225) of the at least one protocol stack 210 of the UE 115-a, and transmit and/or receive RLC PDU to and/or from a peer RLC entity, for example, of the base station 140-a via lower layers (e.g., the PHY layer 240) of the at least one protocol stack 210 of the UE 115-a.

The MAC layer 235 may be capable of, configured to, or operable to support priority handling and multiplexing of logical channels into transport channels. Additionally, the MAC layer 235 may be capable of, configured to, or operable to support error detection techniques, error correction techniques, or both to support retransmissions to improve link efficiency. The PHY layer 240 may be capable of, configured to, or operable to support mapping transport channels to physical channels. Additionally, the PHY layer 240 may be capable of, configured to, or operable to support coding/decoding, modulation/demodulation, multiantenna mapping, etc.

The UE 115-a may be equipped with memory 245 and processor 255. One or more of the at least one protocol stack 210, memory 245, or processor 255 may be in electronic communication or otherwise coupled (e.g., operatively, communicatively, functionally, electronically, electrically) via one or more buses (or interfaces). The memory 245 may store computer-readable, computer-executable, or processor-executable code, such as code 250. The processor 255 may include one or more intelligent hardware devices (e.g., one or more general-purpose processors, one or more DSPs, one or more central processing units (CPUs), one or more graphics processing units (GPUs), one or more neural processing units (NPUs)), or any combination thereof).

The processor 255 may be configured to execute computer-readable instructions stored in the memory 245 to cause the UE 115-a to perform various functions. For example, the code 250 may include instructions that, when executed by the at least one processor 255, causes the UE 115-a (e.g., one or more protocol layers of the at least one protocol stack 210) to perform various functions (e.g., operations, actions, etc.) described herein. For example, the code 250 may be associated with one or more learning models (e.g., AI/ML models). In the example of FIG. 2, the code 250 may include instructions that, when executed by the at least one processor 255, causes the UE 115-a (e.g., one or more protocol layers of the at least one protocol stack 210) to process one or more SDUs (e.g., one or more SDUs 260-a, one or more SDUs 260-b) according to one or more learning models (e.g., one or more AI/ML models). The one or more learning models (e.g., one or more AI/ML models) may improve efficient processing (e.g., transmitting, discarding) of one or more SDUs (e.g., MAC SDUs) at the MAC layer 235 of the at least one protocol stack 210 of the UE 115-a.

The base station 140-a may receive, and the UE 115-a may transmit, a report 265 including capability information that indicates whether the UE 115-a supports one or more functionalities. For example, the base station 140-a may transmit, and the UE 115-a may receive, a UE capability enquiry. In response to the UE capability enquiry message, the UE 115-a may transmit, and the base station 140-a may receive, UE capability information that indicates whether the UE 115-a supports learning functionality (e.g., AI/ML functionality). For example, the UE capability information may indicate whether the UE 115-a supports a learning model (e.g., an AI/ML model) associated with DSR for each of one or more LCHs (e.g., a LCH 262-a, a LCH 262-b) of a group of LCHs (e.g., including at least one of the LCH 262-a and the LCH 262-b) associated with the MAC layer 235 (also referred to a MAC entity) of the UE 115-a. That is, the UE capability information may indicate whether the UE 115-a supports selecting a value for a remaining time threshold associated with a discard timer (e.g., a PDCP discard timer) according to (e.g., based at least in part on) the learning model (e.g., the AI/ML model). Additionally, the UE capability information may indicate whether the UE 115-a supports performance reporting for the learning model (e.g., the AI/ML model). That is, the UE capability information may indicate whether the UE 115-a supports collecting and reporting data related to selecting the value for the remaining time threshold associated with the discard timer.

The base station 140-a may transmit, and the UE 115-a may receive a configuration 270 including a first set of one or more parameters associated with DSR for each of one or more LCH (e.g., one or more of the LCH 262-a or the LCH 262-b) of a group of LCHs (e.g., including one or more of the LCH 262-a or the LCH 262-b) associated with the MAC layer 235 of the UE 115-a. For example, the base station 140-a may transmit, and the UE 115-a may receive an RRC configuration including the first set of one or more parameters. In some examples, the base station 140-a may transmit, and the UE 115-a may receive the RRC configuration in response to (e.g., based at least in part on) the UE capability enquiry. In some examples, the first set of one or more parameters may include at least one parameter that indicates whether to enable or disable the learning model (e.g., the AI/ML model) associated with DSR. That is, the base station 140-a may configure whether the UE 115-a may select the value for the remaining time threshold associated with the discard timer according to the learning model (e.g., the AI/ML model). Additionally, the first set of one or more parameters may include one or more other parameters.

At least one parameter of the first set of one or more parameters is associated with a plurality of values. For example, the remaining time threshold may be associated with a range of values. The base station 140-a may configure a set of values and/or one or more boundaries for the remaining time threshold (e.g., an upper and lower boundary. In some examples, the first set of one or more parameters may include at least one parameter (e.g., minSelectedRemainingTimeThreshold) that indicates a minimum value for the remaining time threshold associated with the discard timer. That is, the at least one parameter may indicate the minimum value the UE 115-a may select for the remaining time threshold associated with the discard timer (e.g., the PDCP discard timer). In some examples, the first set of one or more parameters may include at least one parameter (e.g., maxSelectedRemainingTimeThreshold) that indicates a maximum value for the remaining time threshold associated with the discard timer. That is, the at least one parameter may indicate the maximum value the UE 115-a may select for the remaining time threshold associated with the discard timer (e.g., the PDCP discard timer).

The base station 140-a may configure whether and how the UE 115-a may be allowed to override a configured value for the remaining time threshold associated with the discard timer. When the UE 115-a selects a new value for the remaining time threshold associated with the discard timer, the UE 115-a may report the selected new value to the base station 140. In some examples, the UE 115-a may be allowed to override a value for the remaining time threshold associated with the discard timer configured by the base station 140-a with a selected value for the remaining time threshold by the UE 115-a. As such, if the UE 115-a is allowed to override the remaining time threshold configured by the base station 140-a with the selected value by the UE 115-a, the base station 140-a may have to determine which value the UE 115-a is using, to adapt one or more scheduling policies.

In some other examples, the UE 115-a might not be allowed to override the value for the remaining time threshold associated with the discard timer configured by the base station 140-a with the selected value for the remaining time threshold by the UE 115-a. As such, if the UE 115-a is not allowed to override the remaining time threshold configured by the base station 140-a with the selected value by the UE 115-a, the base station 140-a may use a reported value by the UE 115-a as a recommendation, which the base station 140-a may use for a reconfiguration of the UE 115-a, or of other UEs 115 (not shown). In other examples, the UE 115-a may be allowed to override the value for the remaining time threshold associated with the discard timer based on a condition (e.g., in response to a percentage of SDUs, such as one or more SDUs 260-a or one or more SDUs 260-b) being discarded, the percentage may be configured by the base station 140-a).

The base station 140-a may use the recommendation to update the value of the remaining time threshold that the UE 115-a (or other UEs) is using. In some examples, the base station 140-a may reconfigure the UE 115-a with a new value of the remaining time threshold via an RRC reconfiguration procedures. In other examples, the base station 140-a may reconfigure the UE 115-a with a new value of the remaining time threshold via by transmitting an indication of the new value via MAC-CE and/or DCI. For example, the UE 115-a may be configured with (e.g., via an RRC configuration) with a set of values for the remaining time threshold (e.g., a table of values for the remaining time threshold) for each LCG (e.g., the LCH 262-a and the LCH 262-b). As such, the MAC-CE and/or DCI may include a first indication (e.g., an index, identifier) of a LCH (e.g., the LCH 262-a, the LCH 262-b) and a second indication (e.g., index) that points to the set of values for the remaining time threshold for the LCH (e.g., the LCH 262-a, the LCH 262-b). The successful reception of the MAC-CE and/or DCI may be confirmed by the UE 115-a via a transmission of a HARQ-ACK.

One or more parameters of the first set of one or more parameters may be associated with whether and how the UE 115-a may be allowed to override a configured value for the remaining time threshold associated with the discard timer. In some examples, the first set of one or more parameters may include at least one parameter (e.g., overrideBySelectedRemainingTimeThreshold) that indicates whether to override a current value (e.g., a default value or a previously configured value) of the remaining time threshold associated with the discard timer (e.g., the PDCP discard timer). That is, the at least one parameter may control whether the UE 115-a may override (e.g., update) the current value of the remaining time threshold associated with the discard timer (e.g., the PDCP discard timer). In some examples, the first set of one or more parameters may include at least one parameter (e.g., overrideThreshold) that indicates a threshold value to be satisfied prior to an override of the current value of the remaining time threshold associated with the discard timer (e.g., the PDCP discard timer).

The UE 115-a may generate and transmit a report 275 associated with the learning model (e.g., the AI/ML model). The report 275 may include a set of one or more logs associated with processing (e.g., transmitting, buffering, discarding) of the one or more SDUs (e.g., one or more SDUs 260-a, one or more SDUs 260-b) according to the learning model and one or more selected values for the remaining time threshold associated with the discard timer (e.g., the PDCP discard timer). For example, the report 275 may indicate at least one of one or more SDUs (e.g., one or more SDUs 260-a, one or more SDUs 260-b) transmitted by the UE 115-a, one or more SDUs (e.g., one or more SDUs 260-a, one or more SDUs 260-b) buffered (e.g., stored within a buffer or memory) by the UE 115-a, or one or more SDUs (e.g., one or more SDUs 260-a, one or more SDUs 260-b) discarded by the UE 115-a. For each LCG, the base station 140-a may configure the UE 115-a to support data collection and reporting associated with the learning model (e.g., the AI/ML model). The UE 115-a may collect data associated with the one or more selected values for the remaining time threshold associated with the discard timer (e.g., the PDCP discard timer). Additionally, the UE 115-a may collect data associated with latencies from a trigger of a DSR to a delivery of a corresponding SDU that triggered the DSR.

The base station 140-a may configure whether and how the UE 115-a may report a selected value of a remaining time threshold associated with a discard timer for each LCG (e.g., each of the LCH 262-a and the LCH 262-b). In some examples, the UE 115-a may be configured to transmit an indication of a selected value of a remaining time threshold associated with a discard timer via MAC-CE. In other examples, the UE 115-a may be configured to transmit an indication of a selected value of a remaining time threshold associated with a discard timer via UCI.

One or more parameters of the first set of one or more parameters may be associated with data collection and reporting. In some examples, the first set of one or more parameters may include at least one parameter (e.g., selectedRemainingTimeThresholdReport) that indicates whether to report the selected value for the remaining time threshold associated with the discard timer (e.g., the PDCP discard timer). In some examples, the at least one parameter may configure the UE 115-a to refrain from reporting the selected value for the remaining time threshold associated with the discard timer (e.g., the PDCP discard timer). In some other examples, the at least one parameter may configure the UE 115-a to periodically report the selected value for the remaining time threshold associated with the discard timer (e.g., the PDCP discard timer).

Additionally, or alternatively, the UE 115-a may be configured to report the selected value of the remaining time threshold associated with a discard timer based on an event trigger (e.g., if there is a change in value of the remaining time threshold). In other examples, the first set of one or more parameters may include at least one parameter that may configure the UE 115-a to report the selected value for the remaining time threshold based on an event (also referred to as event-based reporting trigger). By way of example, if a difference between a selected value for the remaining time threshold and a current value for the remaining time threshold satisfies (e.g., exceeds) a threshold, the UE 115-a may report the selected value for the remaining time threshold to the base station 140-a. In some examples, the first set of one or more parameters may include at least one parameter (e.g., selectedRemainingTimeThresholdReportingPeriod) that indicates a duration (e.g., period) for periodic reporting of the selected value for the remaining time threshold associated with the discard timer (e.g., the PDCP discard timer).

Additionally, or alternatively, the UE 115-a may be configured to report the selected value of the remaining time threshold associated with a discard timer periodically or event triggered (e.g., if there is a change in value of the remaining time threshold). In some examples, the first set of one or more parameters may include at least one parameter (e.g., selectedRemainingTimeThresholdProhibitTimer) that indicates a duration (e.g., period) for event-based reporting of the value of the remaining time threshold associated with the discard timer (e.g., the PDCP discard timer). That is, the UE 115-a may be configured to enable a prohibit timer, which may prevent the UE 115-a from transmitting excessive (e.g., too many) reports (e.g., indicating selected values of remaining time threshold associated with discard timers (e.g., PDCP discard timers)).

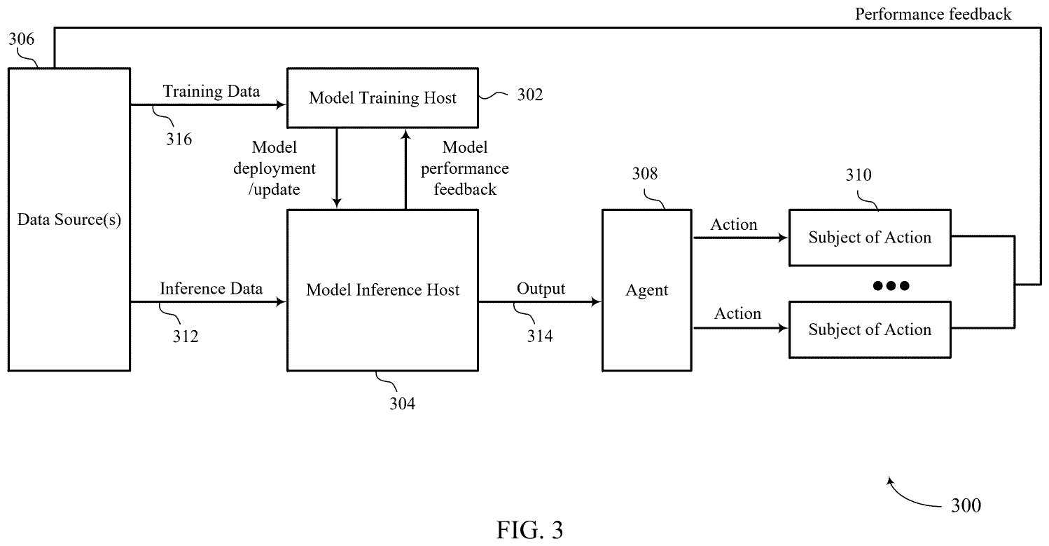

FIG. 3 shows an example of an ML architecture 300 that supports AI-enabled MAC DSR in accordance with one or more aspects of the present disclosure. The ML architecture 300 may be used for wireless communications in any of the various implementations, processes, environments, networks, or use cases listed above. As illustrated, the ML architecture 300 may include multiple logical entities, such as model training host 302, model inference host 304, data source(s) 306, and agent 308. The model inference host 304 may be configured to run a learning model (e.g., an AI/ML model) based on inference data 312 provided by data source(s) 306. The model inference host 304 may produce output 314, which may include a prediction or inference, such as a discrete or continuous value based on inference data 312, which may then be provided as input to the agent 308.

The agent 308 may represent an element or an entity of a wireless communication system including, for example, a radio access network (RAN), a wireless local area network, a device-to-device (D2D) communications system, etc. As an example, the agent 308 may be a UE (e.g., UE 115 as described with reference to FIGS. 1, 2, and 4 through 8), a base station (e.g., a base station 140 as described with reference to FIGS. 1, 2, and 9 through 12), or a disaggregated network entity (such as a CU, a DU, or a RU as described with reference to FIG. 1), an access point, a wireless station, a RIC in a cloud-based RAN, among some examples. Additionally, the agent 308 also may be a type of agent that depends on the type of tasks performed by the model inference host 304, the type of inference data 312 provided to the model inference host 304, or the type of output 314 produced by the model inference host 304.

The agent 308 may perform one or more actions associated with receiving the output 314 from the model inference host 304. For example, if the agent 308 is a UE 115 and the output from the model inference host 304 is associated with DSR for each of one or more LCHs of a group of LCHs, the agent 308 may adjust parameters dynamically for processing AI-enabled MAC entity related operations associated with the agent 308 (e.g., selecting a value for a timer associated with the DSR, processing (e.g., transmitting, buffering, discarding) one or more SDUs for each of one or more LCHs of a group of LCHs) based on the output 314.

The agent 308 may indicate the one or more actions performed to at least one subject of action 310. For example, if the agent 308 adjusts parameters dynamically for processing AI-enabled MAC entity related operations associated with the agent 308 (e.g., selecting a value for a timer associated with the DSR, processing (e.g., transmitting, buffering, discarding) one or more SDUs for each of one or more LCHs of a group of LCHs), the agent 308 may output an indication to the subject of action 310 (such as, one or more protocol layers of the UE 115).

As another example, the agent 308 may be a UE 115 and the output 314 from the model inference host 304 may include one or more characteristics for processing AI-enabled MAC entity related operations (e.g., selecting a value for a timer associated with the DSR, processing one or more SDUs for each of one or more LCHs of a group of LCHs). For example, the model inference host 304 may predict threshold values for selecting a value for a timer associated with the DSR based on one or more parameters of a first set of one or more parameters. Based on the predicted threshold values, the agent 308 may adjust parameters dynamically for processing AI-enabled MAC entity related operations (e.g., processing one or more SDUs for each of one or more LCHs of a group of LCHs) and output the adjusted parameters to the subject of action 310 (such as, one or more protocol layers of the UE 115 as described with reference to FIG. 2). In some cases, the agent 308 and the subject of action 310 are the same entity.

Data can be collected from the data sources 306, and may be used as training data 316 for training a learning model (e.g., an AI/ML model), or as inference data 312 for feeding an ML model inference operation. Data sources 306 may collect data from various subject of action 310 entities (such as, a network entity 105, a UE 115, and/or a base station 140), and provide the collected data to a model training host 302 for ML model training. For example, after a subject of action 310 (such as, a UE 115) obtains one or more parameters from agent 308, the subject of action 310 may provide performance feedback associated with the one or more parameters to the data sources 306. The performance feedback may be used by the model training host 302 for monitoring or evaluating the learning model performance (e.g., AI/ML model performance). In some examples, if output 314 provided to agent 308 is inaccurate (or the accuracy is below an accuracy threshold), model training host 302 may provide feedback to model inference host 304 to modify or retrain the learning model (e.g., AI/ML model) used by model inference host 304, such as via an ML model deployment update.

The model training host 302 may be deployed at the same or a different entity than that in which model inference host 304 is deployed. For example, in order to offload model training processing, which can impact the performance of model inference host 304, model training host 302 may be deployed at a model server. In some examples, an ML model may be deployed at or on a network entity (such as a network entity 105 or a base station 140) for supporting AI-enabled MAC entity related operations (e.g., selecting a value for a timer associated with the DSR, processing one or more SDUs for each of one or more LCHs of a group of LCHs). More specifically, a model interference host, such as model inference host 304 in FIG. 3, may be deployed at or on the network entity 105 for such operations. In some other examples, an ML model may be deployed at or on a UE (such as UE 115) for AI-enabled MAC entity related operations (e.g., selecting a value for a timer associated with the DSR, processing one or more SDUs for each of one or more LCHs of a group of LCHs). More specifically, a model inference host, such as model inference host 304 in FIG. 3, may be deployed at or on the UE for such operations.

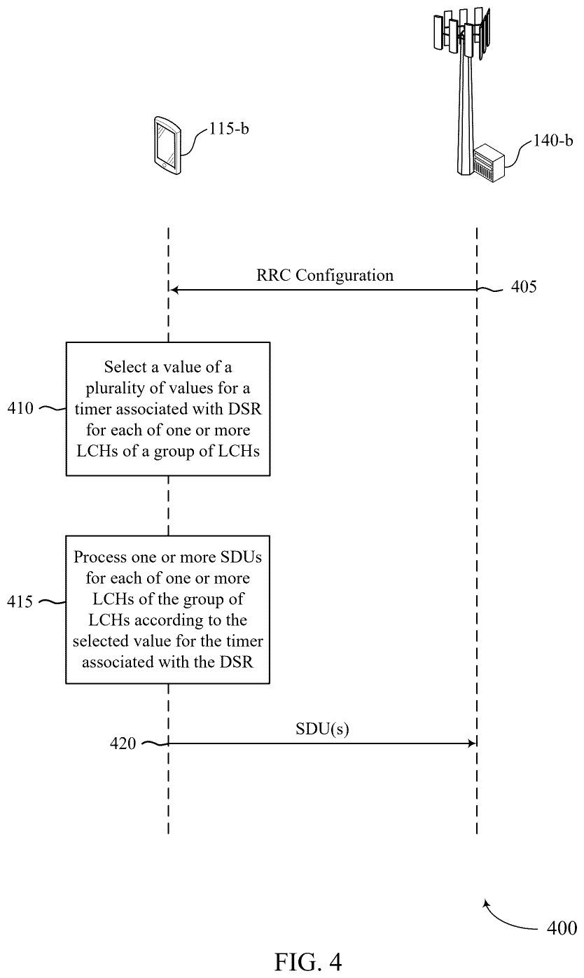

FIG. 4 shows an example of a process flow 400 that supports AI-enabled MAC DSR in accordance with one or more aspects of the present disclosure. The process flow 400 may implement aspects of the wireless communications system 100 as described with reference to FIG. 1. The process flow 400 may include a UE 115-b and a base station 140-b, which may be examples of UEs 115 and base stations 140 as described herein. In the following description of the process flow 400, the operations between the UE 115-b and the base station 140-b may be transmitted in a different order than the example order shown, or the operations performed by the UE 115-b and the base station 140-b may be performed in different orders or at different times. Some operations may also be omitted from the process flow 400, and other operations may be added to the process flow 400.

At 405, the base station 140-b may transmit, and the UE 115-b may receive, an RRC configuration. The RRC configuration may include a first set of one or more parameters associated with DSR for each of one or more LCHs of a group of LCHs associated with a MAC entity of the UE 115-b. The first set of one or more parameters may be an input to a learning model (e.g., an AI/ML model) associated with the DSR.

At 410, the UE 115-b may select a value of a plurality of values for a timer associated with DSR for each of one or more LCHs of a group of LCHs. For example, at least one parameter (e.g., remainingTimeThreshold) of the first set of one or more parameters may be associated with the plurality of values. As such, the UE 115-b may select a value for the remainingTimeThreshold associated with DSR. In some examples, the UE 115-b may select the value for the remainingTimeThreshold associated with DSR based at least in part on a second set of one or more parameters. The second set of one or more parameters may be an output of the learning model (e.g., the AI/ML model). For example, the second set of one or more parameters may include a minimum value for the remainingTimeThreshold or a maximum value for the remainingTimeThreshold. The UE 115-b may select a value for the remainingTimeThreshold as the minimum value or the maximum value outputted by the learning model (e.g., the AI/ML model). Alternatively, the second set of one or more parameters may include a value for the remainingTimeThreshold associated with DSR, where the value is determined by the learning model (e.g., the AI/ML model) based at least in part on one or more conditions, such as a percentage of SDUs being at least one of discarded or transmitted within a duration. The learning model (e.g., the AI/ML model) may thereby output a value for the remainingTimeThreshold associated with DSR, which may enhance network and UE performance, resource management, and quality of service (QOS) quality.

At 415, the UE 115-b may process one or more SDUs for each of one or more LCHs of the group of LCHs according to the selected value for the timer associated with the DSR. At 420, the UE 115-b may process the one or more SDUs by outputting (e.g., transmitting) to the base station 140-b the one or more SDUs.

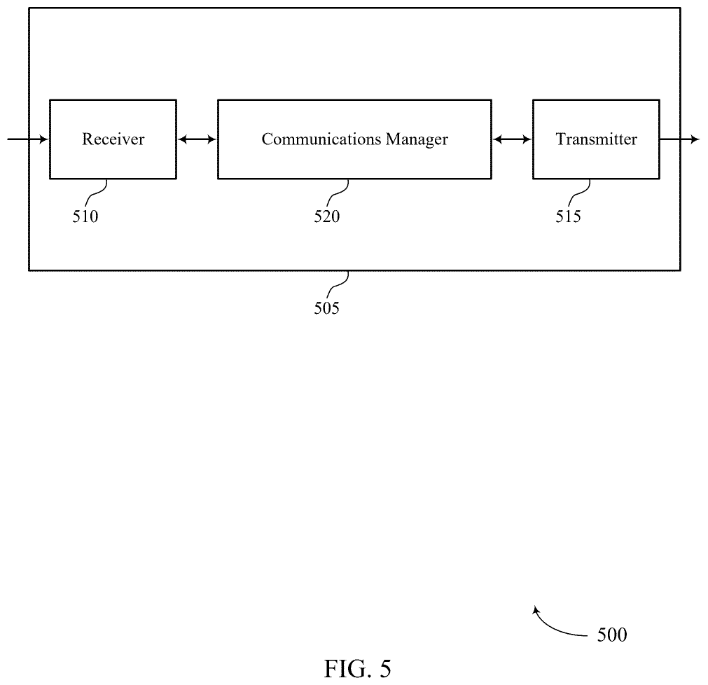

FIG. 5 shows a block diagram 500 of a device 505 that supports AI-enabled MAC DSR in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to AI-enabled MAC DSR). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to AI-enabled MAC DSR). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of AI-enabled MAC DSR as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling that indicates a configuration including a first set of one or more parameters associated with DSR for each of one or more LCHs of a group of LCHs associated with a MAC entity of the device 505, where at least one parameter of the first set of one or more parameters is associated with a set of multiple values. The communications manager 520 is capable of, configured to, or operable to support a means for selecting a value of the set of multiple values for a timer associated with the DSR for each of one or more LCHs of the group of LCHs based on a second set of one or more parameters. The communications manager 520 is capable of, configured to, or operable to support a means for processing one or more SDUs for each of one or more LCHs of the group of LCHs according to the selected value of the set of multiple values for the timer associated with the DSR.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption.

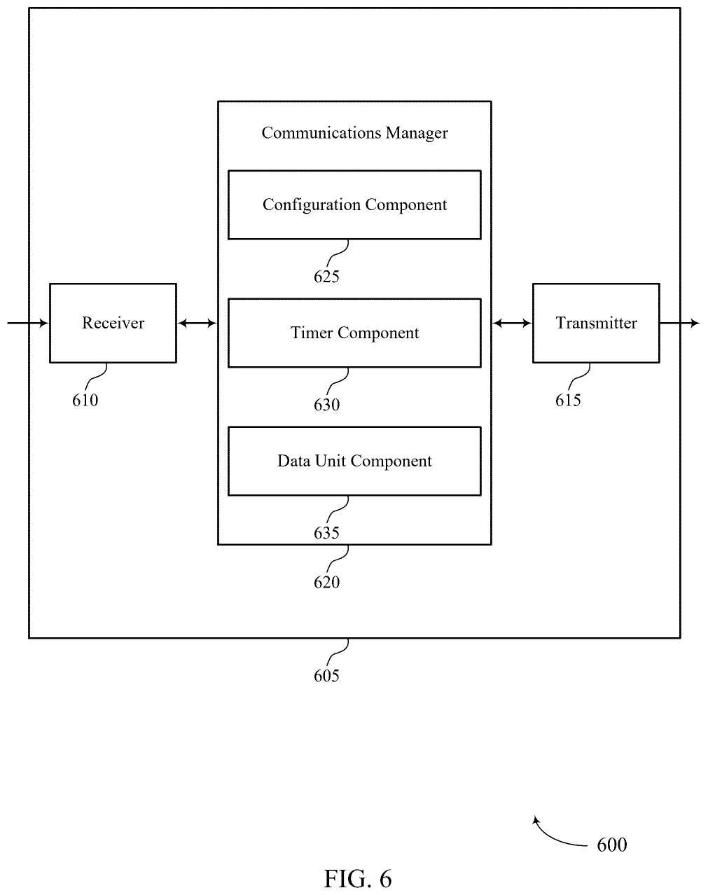

FIG. 6 shows a block diagram 600 of a device 605 that supports AI-enabled MAC DSR in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to AI-enabled MAC DSR). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to AI-enabled MAC DSR). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of AI-enabled MAC DSR as described herein. For example, the communications manager 620 may include a configuration component 625, a timer component 630, a data unit component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving control signaling that indicates a configuration including a first set of one or more parameters associated with DSR for each of one or more LCHs of a group of LCHs associated with a MAC entity of the device 605, where at least one parameter of the first set of one or more parameters is associated with a set of multiple values. The timer component 630 is capable of, configured to, or operable to support a means for selecting a value of the set of multiple values for a timer associated with the DSR for each of one or more LCHs of the group of LCHs based on a second set of one or more parameters. The data unit component 635 is capable of, configured to, or operable to support a means for processing one or more SDUs for each of one or more LCHs of the group of LCHs according to the selected value of the set of multiple values for the timer associated with the DSR.

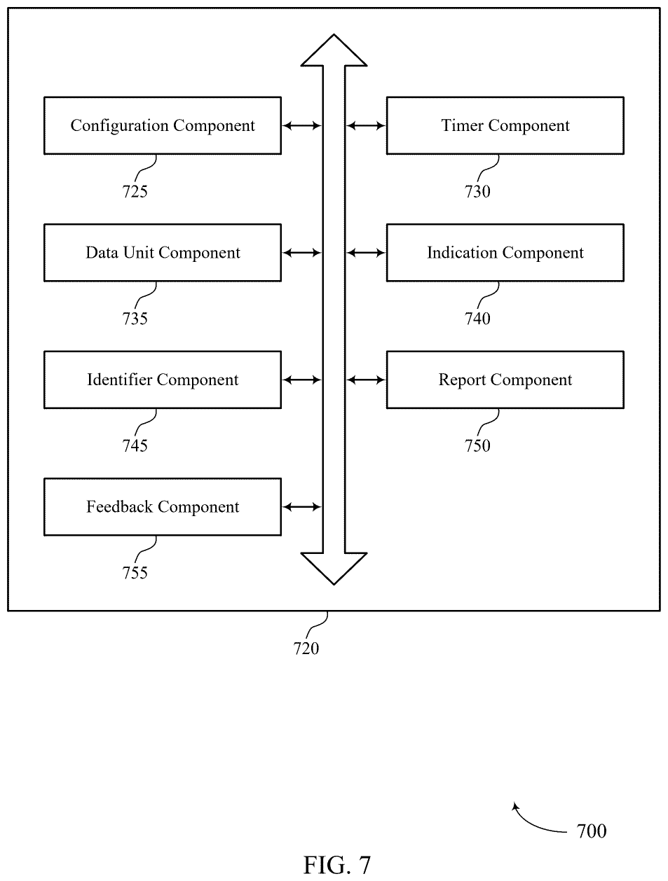

FIG. 7 shows a block diagram 700 of a communications manager 720 that supports AI-enabled MAC DSR in accordance with one or more aspects of the present disclosure. The communications manager 720 may be an example of aspects of a communications manager 520, a communications manager 620, or both, as described herein. The communications manager 720, or various components thereof, may be an example of means for performing various aspects of AI-enabled MAC DSR as described herein. For example, the communications manager 720 may include a configuration component 725, a timer component 730, a data unit component 735, an indication component 740, an identifier component 745, a report component 750, a feedback component 755, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving control signaling that indicates a configuration including a first set of one or more parameters associated with DSR for each of one or more LCHs of a group of LCHs associated with a MAC entity of a wireless device (e.g., the device 505, the device 605, and/or the device 805 as described herein), where at least one parameter of the first set of one or more parameters is associated with a set of multiple values. The timer component 730 is capable of, configured to, or operable to support a means for selecting a value of the set of multiple values for a timer associated with the DSR for each of one or more LCHs of the group of LCHs based on a second set of one or more parameters. The data unit component 735 is capable of, configured to, or operable to support a means for processing one or more SDUs for each of one or more LCHs of the group of LCHs according to the selected value of the set of multiple values for the timer associated with the DSR.

In some examples, the first set of one or more parameters includes an input to a learning model associated with the DSR for each of one or more LCHs of the group of LCHs associated with the MAC entity. In some examples, the second set of one or more parameters includes an output of the learning model associated with the DSR for each of one or more LCHs of the group of LCHs associated with the MAC entity. In some examples, selecting the value of the set of multiple values for the timer associated with the DSR is based on the input to the learning model and the output of the learning model.

In some examples, at least one parameter of the first set of one or more parameters includes an indication to enable or disable a learning model associated with the DSR for each of one or more LCHs of the group of LCHs.

In some examples, one or more parameters of the first set of one or more parameters includes a lower boundary value for the timer associated with the DSR for each of one or more LCHs of the group of LCHs or an upper boundary value for the timer associated with the DSR for each of one or more LCHs of the group of LCHs. In some examples, the one or more parameters of the first set of one or more parameters includes a range of values for the timer associated with the DSR for each of one or more LCHs of the group of LCHs.

In some examples, one or more parameters of the first set of one or more parameters includes a first indication that the MAC entity is allowed to override a default value for the timer associated with the DSR for each of one or more LCHs of the group of LCHs, a second indication that the MAC entity is prohibited to override the default value for the timer associated with the DSR for each of one or more LCHs of the group of LCHs, or a second indication that the MAC entity is allowed to override the default value of the timer associated with the DSR for each of one or more LCHs of the group of LCHs based on a condition.

In some examples, the indication component 740 is capable of, configured to, or operable to support a means for transmitting an indication of the selected value of the set of multiple values for the timer associated with the DSR for each of one or more LCHs of the group of LCHs, where the indication includes a MAC-CE or UCI.

In some examples, transmitting the indication of the selected value of the set of multiple values for the timer associated with the DSR for each of one or more LCHs of the group of LCHs is based on a periodicity or a condition.

In some examples, transmitting the indication of the selected value of the set of multiple values for the timer associated with the DSR for each of one or more LCHs of the group of LCHs is based on a prohibit timer.

In some examples, the configuration includes an RRC configuration.

In some examples, the identifier component 745 is capable of, configured to, or operable to support a means for receiving second control signaling that indicates a LCH identifier, where the LCH identifier maps to one or more LCHs of the group of LCHs associated with the MAC entity. In some examples, the second control signaling further indicates the value of the set of multiple values for the timer associated with the DSR for each of one or more LCHs of the group of LCHs. In some examples, the second control signaling includes a MAC-CE or DCI. In some examples, selecting the value of the set of multiple values for the timer associated with the DSR is based on the received second control signaling. In some examples, the feedback component 755 is capable of, configured to, or operable to support a means for transmitting a HARQ acknowledgment based on the received second control signaling.

In some examples, the report component 750 is capable of, configured to, or operable to support a means for generating a report associated with a learning model, where the report includes a set of one or more logs associated with processing of the one or more SDUs according to the learning model and one or more selected values of the set of multiple values for the timer associated with the DSR for each of one or more LCHs of the group of LCHs. In some examples, the report component 750 is capable of, configured to, or operable to support a means for transmitting the report associated with the learning model to a network entity or a second wireless device.

In some examples, the report is based on a reporting configuration, an event-based reporting trigger, or a prohibit timer.

In some examples, the report component 750 is capable of, configured to, or operable to support a means for transmitting, to a network entity or a second wireless device, a report including capability information that indicates whether the wireless device (e.g., the device 505, the device 605, and/or the device 805 as described herein) supports a learning model associated with the DSR for each of one or more LCHs of the group of LCHs associated with the MAC entity, where the capability information further indicates whether the wireless device supports performance reporting for the learning model associated with the DSR for each of one or more LCHs of the group of LCHs associated with the MAC entity, where the control signaling that indicates the configuration is received based on the capability information.

In some examples, at least one parameter of the first set of one or more parameters includes a minimum value for the timer associated with the DSR for each of one or more LCHs of the group of LCHs.

In some examples, at least one parameter of the first set of one or more parameters includes a maximum value for the timer associated with the DSR for each of one or more LCHs of the group of LCHs.

In some examples, at least one parameter of the first set of one or more parameters includes an indication to override a current value of the timer associated with the DSR for each of one or more LCHs of the group of LCHs by the selected value.

In some examples, at least one parameter of the first set of one or more parameters includes an indication of a threshold value to be satisfied prior to an override of a current value of the timer associated with the DSR for each of one or more LCHs of the group of LCHs by the selected value.

In some examples, at least one parameter of the first set of one or more parameters includes an indication for reporting of the timer associated with the DSR for each of one or more LCHs of the group of LCHs.

In some examples, at least one parameter of the first set of one or more parameters includes a duration for periodic reporting of the timer associated with the DSR for each of one or more LCHs of the group of LCHs.

In some examples, at least one parameter of the first set of one or more parameters includes a duration for event-based reporting of the timer associated with the DSR for each of one or more LCHs of the group of LCHs.

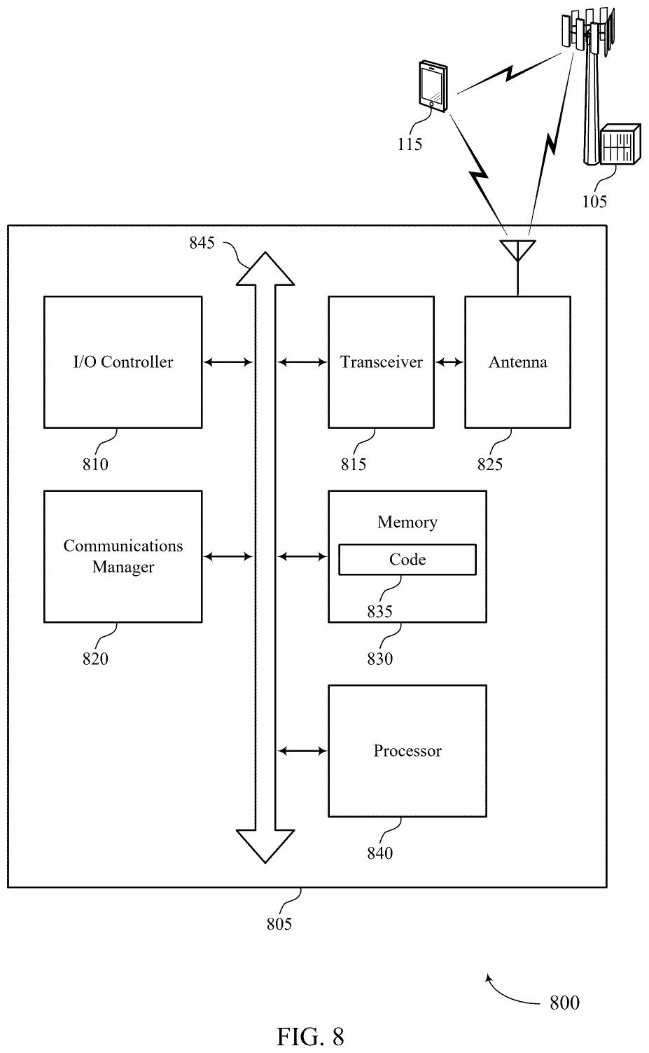

FIG. 8 shows a diagram of a system 800 including a device 805 that supports AI-enabled MAC DSR in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting AI-enabled MAC DSR). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling that indicates a configuration including a first set of one or more parameters associated with DSR for each of one or more LCHs of a group of LCHs associated with a MAC entity of the device 805, where at least one parameter of the first set of one or more parameters is associated with a set of multiple values. The communications manager 820 is capable of, configured to, or operable to support a means for selecting a value of the set of multiple values for a timer associated with the DSR for each of one or more LCHs of the group of LCHs based on a second set of one or more parameters. The communications manager 820 is capable of, configured to, or operable to support a means for processing one or more SDUs for each of one or more LCHs of the group of LCHs according to the selected value of the set of multiple values for the timer associated with the DSR.

By including or configuring the communications manager 820 in accordance with examples as described herein, the device 805 may support techniques for reduced power consumption, longer battery life, and reduced processing.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of AI-enabled MAC DSR as described herein, or the at least one processor 840 and the at least one memory 830 may be otherwise configured to, individually or collectively, perform or support such operations.

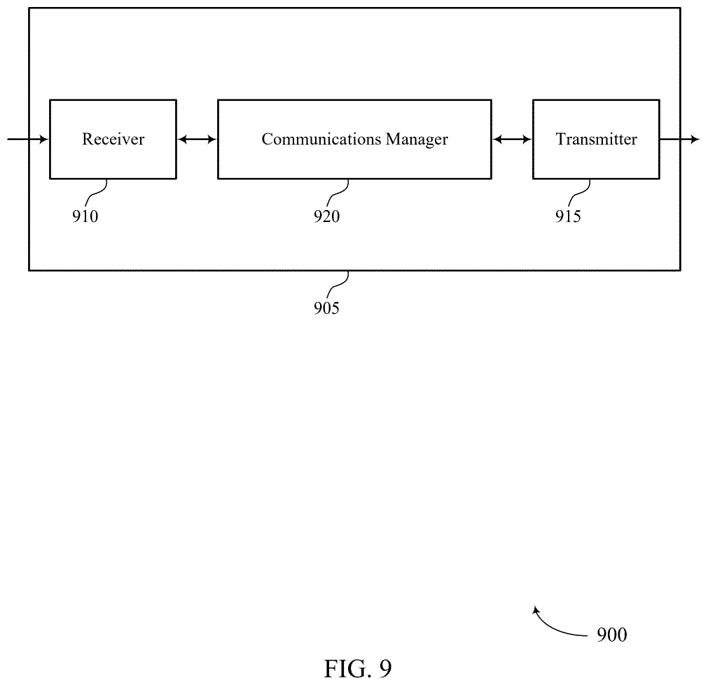

FIG. 9 shows a block diagram 900 of a device 905 that supports AI-enabled MAC DSR in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, PDUs, SDUs) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, PDUs, SDUs) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of AI-enabled MAC DSR as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values. The communications manager 920 is capable of, configured to, or operable to support a means for receiving one or more SDUs for each of one or more LCHs of the group of LCHs.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

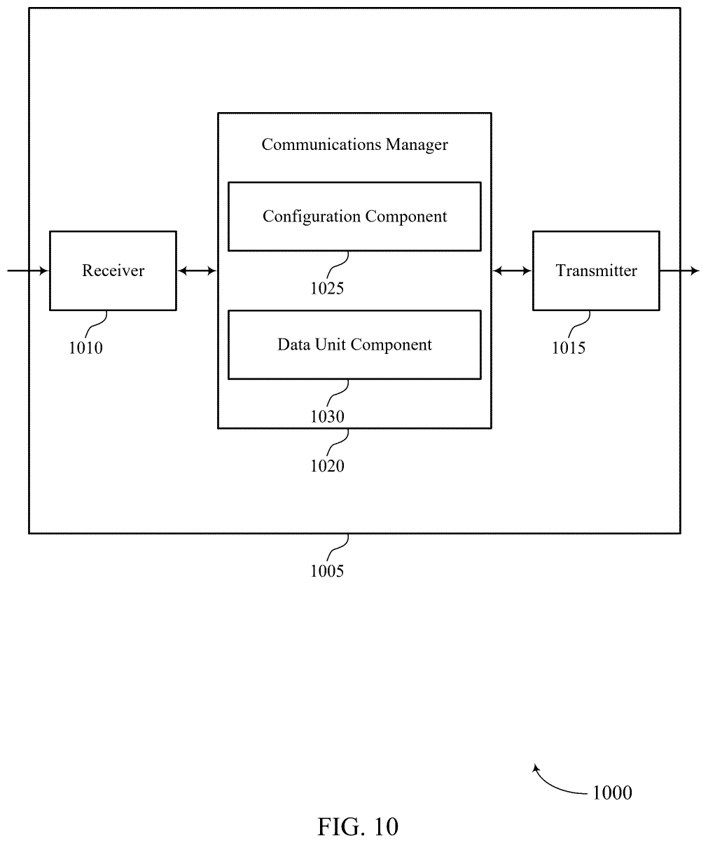

FIG. 10 shows a block diagram 1000 of a device 1005 that supports AI-enabled MAC DSR in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, PDUs, SDUs) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, PDUs, SDUs) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of AI-enabled MAC DSR as described herein. For example, the communications manager 1020 may include a configuration component 1025 a data unit component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration component 1025 is capable of, configured to, or operable to support a means for transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values. The data unit component 1030 is capable of, configured to, or operable to support a means for receiving one or more SDUs for each of one or more LCHs of the group of LCHs.

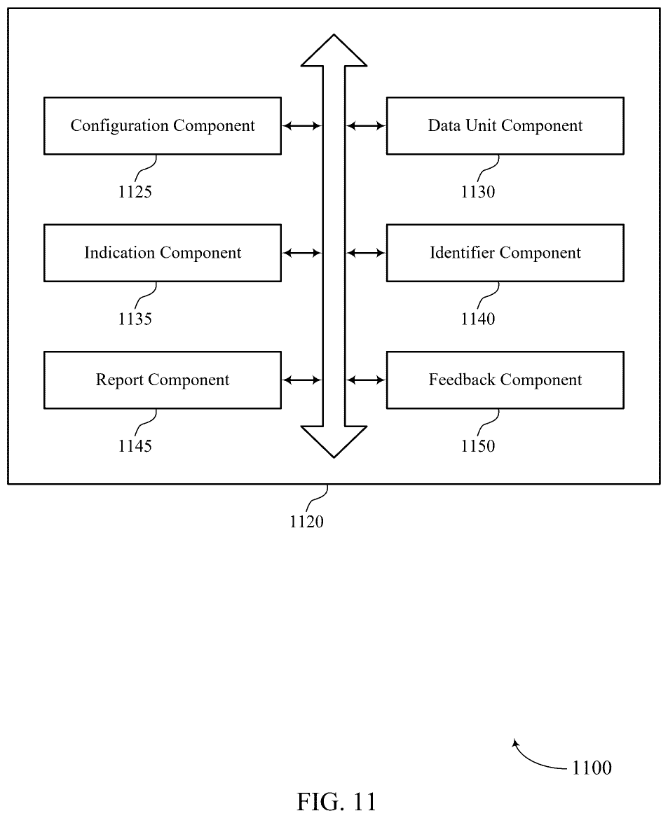

FIG. 11 shows a block diagram 1100 of a communications manager 1120 that supports AI-enabled MAC DSR in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of AI-enabled MAC DSR as described herein. For example, the communications manager 1120 may include a configuration component 1125, a data unit component 1130, an indication component 1135, an identifier component 1140, a report component 1145, a feedback component 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a LCH of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration component 1125 is capable of, configured to, or operable to support a means for transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values. The data unit component 1130 is capable of, configured to, or operable to support a means for receiving one or more SDUs for each of one or more LCHs of the group of LCHs.

In some examples, at least one parameter of the first set of one or more parameters includes an indication to enable or disable a learning model associated with the DSR for each of one or more LCHs of the group of LCHs.

In some examples, the indication component 1135 is capable of, configured to, or operable to support a means for receiving an indication of a selected value of a set of multiple values for a timer associated with the DSR for each of one or more LCHs of the group of LCHs, where the indication includes a MAC-CE or UCI.

In some examples, the configuration includes an RRC configuration.

In some examples, the identifier component 1140 is capable of, configured to, or operable to support a means for transmitting second control signaling that indicates a LCH identifier, where the LCH identifier maps to one or more LCHs of the group of LCHs associated with the MAC entity, where the second control signaling further indicates a value of a set of multiple values for a timer associated with the DSR for each of one or more LCHs of the group of LCHs, and where the second control signaling includes a MAC-CE or DCI.

In some examples, the feedback component 1150 is capable of, configured to, or operable to support a means for receiving HARQ acknowledgment based on the transmitted second control signaling.

In some examples, the report component 1145 is capable of, configured to, or operable to support a means for receiving a report associated with a learning model, where the report is based on a reporting configuration, an event-based reporting trigger, or a prohibit timer.

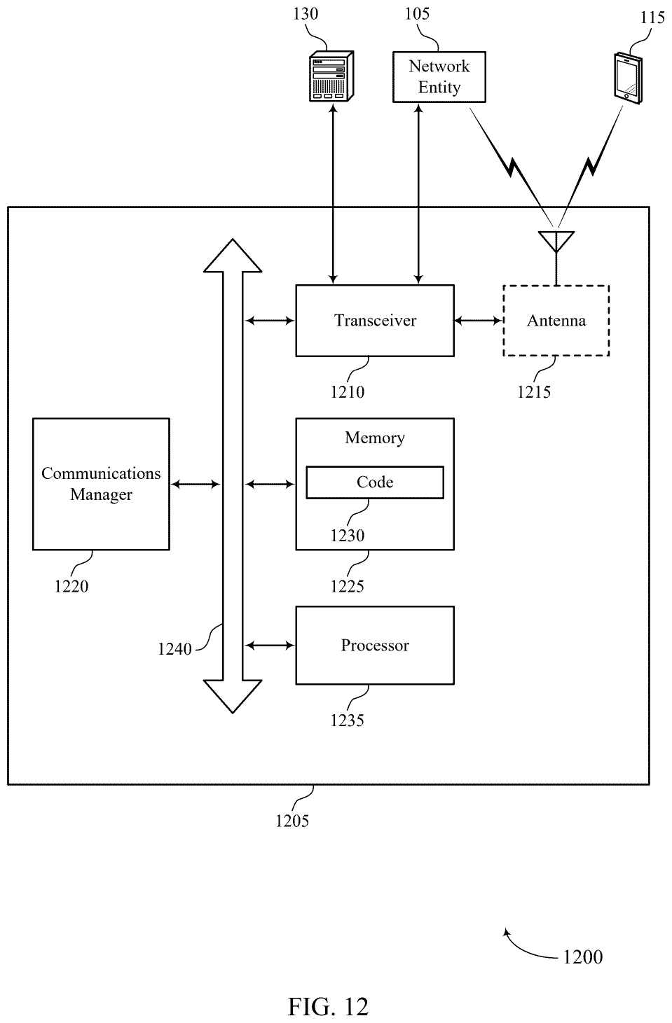

FIG. 12 shows a diagram of a system 1200 including a device 1205 that supports AI-enabled MAC DSR in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting AI-enabled MAC DSR). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a LCH of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values. The communications manager 1220 is capable of, configured to, or operable to support a means for receiving one or more SDUs for each of one or more LCHs of the group of LCHs.

By including or configuring the communications manager 1220 in accordance with examples as described herein, the device 1205 may support techniques for more efficient utilization of communication resources, improved coordination between devices, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of AI-enabled MAC DSR as described herein, or the at least one processor 1235 and the at least one memory 1225 may be otherwise configured to, individually or collectively, perform or support such operations.

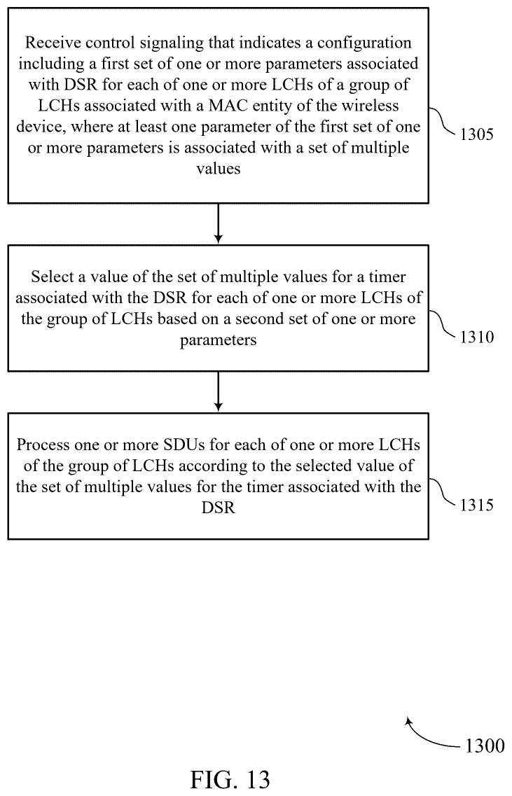

FIG. 13 shows a flowchart illustrating a method 1300 that supports AI-enabled MAC DSR in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving control signaling that indicates a configuration including a first set of one or more parameters associated with DSR for each of one or more LCHs of a group of LCHs associated with a MAC entity of the wireless device, where at least one parameter of the first set of one or more parameters is associated with a set of multiple values. The operations of 1305 may be performed in accordance with examples as disclosed herein. In some examples, aspects of the operations of 1305 may be performed by a configuration component 725 as described with reference to FIG. 7.

At 1310, the method may include selecting a value of the set of multiple values for a timer associated with the DSR for each of one or more LCHs of the group of LCHs based on a second set of one or more parameters. The operations of 1310 may be performed in accordance with examples as disclosed herein. In some examples, aspects of the operations of 1310 may be performed by a timer component 730 as described with reference to FIG. 7.

At 1315, the method may include processing one or more SDUs for each of one or more LCHs of the group of LCHs according to the selected value of the set of multiple values for the timer associated with the DSR. The operations of 1315 may be performed in accordance with examples as disclosed herein. In some examples, aspects of the operations of 1315 may be performed by a data unit component 735 as described with reference to FIG. 7.

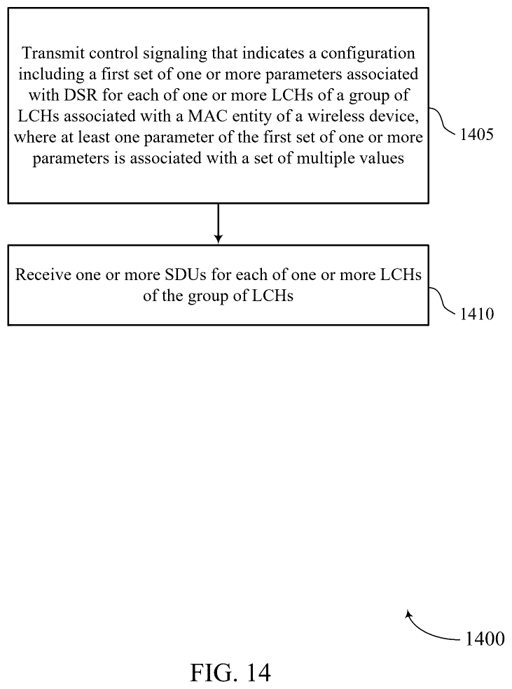

FIG. 14 shows a flowchart illustrating a method 1400 that supports AI-enabled MAC DSR in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting control signaling that indicates a configuration including a first set of one or more parameters associated with DSR for each of one or more LCHs of a group of LCHs associated with a MAC entity of a wireless device, where at least one parameter of the first set of one or more parameters is associated with a set of multiple values. The operations of 1405 may be performed in accordance with examples as disclosed herein. In some examples, aspects of the operations of 1405 may be performed by a configuration component 1125 as described with reference to FIG. 11.

At 1410, the method may include receiving one or more SDUs for each of one or more LCHs of the group of LCHs. The operations of 1410 may be performed in accordance with examples as disclosed herein. In some examples, aspects of the operations of 1410 may be performed by a data unit component 1130 as described with reference to FIG. 11.

It should be noted that the methods described herein describe possible implementations. The operations and the steps may be rearranged or otherwise modified and other implementations are possible. Further, aspects from two or more of the methods may be combined.

The following provides an overview of aspects of the present disclosure:
Aspect 1: A method for wireless communications at a wireless device, comprising: receiving control signaling that indicates a configuration comprising a first set of one or more parameters associated with DSR for each of one or more LCHs of a group of LCHs associated with a MAC entity of the wireless device, wherein at least one parameter of the first set of one or more parameters is associated with a plurality of values; selecting a value of the plurality of values for a timer associated with the DSR for each of one or more LCHs of the group of LCHs based at least in part on a second set of one or more parameters; and processing one or more SDUs for each of one or more LCHs of the group of LCHs according to the selected value of the plurality of values for the timer associated with the DSR.
Aspect 2: The method of aspect 1, wherein the first set of one or more parameters comprises an input to a learning model associated with the DSR for each of one or more LCHs of the group of LCHs associated with the MAC entity, the second set of one or more parameters comprises an output of the learning model associated with the DSR for each of one or more LCHs of the group of LCHs associated with the MAC entity, and selecting the value of the plurality of values for the timer associated with the DSR is based at least in part on the input to the learning model and the output of the learning model.
Aspect 3: The method of any of aspects 1 through 2, wherein at least one parameter of the first set of one or more parameters comprises an indication to enable or disable a learning model associated with the DSR for each of one or more LCHs of the group of LCHs.
Aspect 4: The method of any of aspects 1 through 3, wherein one or more parameters of the first set of one or more parameters comprises a lower boundary value for the timer associated with the DSR for each of one or more LCHs of the group of LCHs or an upper boundary value for the timer associated with the DSR for each of one or more LCHs of the group of LCHs, or the one or more parameters of the first set of one or more parameters comprises a range of values for the timer associated with the DSR for each of one or more LCHs of the group of LCHs.
Aspect 5: The method of any of aspects 1 through 4, wherein one or more parameters of the first set of one or more parameters comprises a first indication that the MAC entity is allowed to override a default value for the timer associated with the DSR for each of one or more LCHs of the group of LCHs, a second indication that the MAC entity is prohibited to override the default value for the timer associated with the DSR for each of one or more LCHs of the group of LCHs, or a second indication that the MAC entity is allowed to override the default value of the timer associated with the DSR for each of one or more LCHs of the group of LCHs based at least in part on a condition.
Aspect 6: The method of any of aspects 1 through 5, further comprising: transmitting an indication of the selected value of the plurality of values for the timer associated with the DSR for each of one or more LCHs of the group of LCHs, wherein the indication comprises a MAC-CE or UCI.
Aspect 7: The method of aspect 6, wherein transmitting the indication of the selected value of the plurality of values for the timer associated with the DSR for each of one or more LCHs of the group of LCHs is based at least in part on a periodicity or a condition.
Aspect 8: The method of any of aspects 6 through 7, wherein transmitting the indication of the selected value of the plurality of values for the timer associated with the DSR for each of one or more LCHs of the group of LCHs is based at least in part on a prohibit timer.
Aspect 9: The method of any of aspects 1 through 8, wherein the configuration comprises an RRC configuration.
Aspect 10: The method of any of aspects 1 through 9, further comprising: receiving second control signaling that indicates a LCH identifier, wherein the LCH identifier maps to one or more LCHs of the group of LCHs associated with the MAC entity, wherein the second control signaling further indicates the value of the plurality of values for the timer associated with the DSR for each of one or more LCHs of the group of LCHs, wherein the second control signaling comprises a MAC-CE or DCI, and wherein selecting the value of the plurality of values for the timer associated with the DSR is based at least in part on the received second control signaling.
Aspect 11: The method of aspect 10, further comprising: transmitting an HARQ acknowledgment based at least in part on the received second control signaling.
Aspect 12: The method of any of aspects 1 through 11, further comprising: generating a report associated with a learning model, wherein the report comprises a set of one or more logs associated with processing of the one or more SDUs according to the learning model and one or more selected values of the plurality of values for the timer associated with the DSR for each of one or more LCHs of the group of LCHs; and transmitting the report associated with the learning model to a network entity or a second wireless device.
Aspect 13: The method of aspect 12, wherein the report is based at least in part on a reporting configuration, an event-based reporting trigger, or a prohibit timer.
Aspect 14: The method of any of aspects 1 through 13, further comprising: transmitting, to a network entity or a second wireless device, a report comprising capability information that indicates whether the wireless device supports a learning model associated with the DSR for each of one or more LCHs of the group of LCHs associated with the MAC entity, wherein the capability information further indicates whether the wireless device supports performance reporting for the learning model associated with the DSR for each of one or more LCHs of the group of LCHs associated with the MAC entity, wherein the control signaling that indicates the configuration is received based at least in part on the capability information.
Aspect 15: The method of any of aspects 1 through 14, wherein at least one parameter of the first set of one or more parameters comprises a minimum value for the timer associated with the DSR for each of one or more LCHs of the group of LCHs.
Aspect 16: The method of any of aspects 1 through 15, wherein at least one parameter of the first set of one or more parameters comprises a maximum value for the timer associated with the DSR for each of one or more LCHs of the group of LCHs.
Aspect 17: The method of any of aspects 1 through 16, wherein at least one parameter of the first set of one or more parameters comprises an indication to override a current value of the timer associated with the DSR for each of one or more LCHs of the group of LCHs by the selected value.
Aspect 18: The method of any of aspects 1 through 17, wherein at least one parameter of the first set of one or more parameters comprises an indication of a threshold value to be satisfied prior to an override of a current value of the timer associated with the DSR for each of one or more LCHs of the group of LCHs by the selected value.
Aspect 19: The method of any of aspects 1 through 18, wherein at least one parameter of the first set of one or more parameters comprises an indication for reporting of the timer associated with the DSR for each of one or more LCHs of the group of LCHs.
Aspect 20: The method of any of aspects 1 through 19, wherein at least one parameter of the first set of one or more parameters comprises a duration for periodic reporting of the timer associated with the DSR for each of one or more LCHs of the group of LCHs.
Aspect 21: The method of any of aspects 1 through 20, wherein at least one parameter of the first set of one or more parameters comprises a duration for event-based reporting of the timer associated with the DSR for each of one or more LCHs of the group of LCHs.
Aspect 22: A method for wireless communications at a network entity, comprising: transmitting control signaling that indicates a configuration comprising a first set of one or more parameters associated with DSR for each of one or more LCHs of a group of LCHs associated with a MAC entity of a wireless device, wherein at least one parameter of the first set of one or more parameters is associated with a plurality of values; and receiving one or more SDUs for each of one or more LCHs of the group of LCHs.
Aspect 23: The method of aspect 22, wherein at least one parameter of the first set of one or more parameters comprises an indication to enable or disable a learning model associated with the DSR for each of one or more LCHs of the group of LCHs.
Aspect 24: The method of any of aspects 22 through 23, further comprising: receiving an indication of a selected value of a plurality of values for a timer associated with the DSR for each of one or more LCHs of the group of LCHs, wherein the indication comprises a MAC-CE or UCI.
Aspect 25: The method of any of aspects 22 through 24, wherein the configuration comprises an RRC configuration.
Aspect 26: The method of any of aspects 22 through 25, further comprising: transmitting second control signaling that indicates a LCH identifier, wherein the LCH identifier maps to one or more LCHs of the group of LCHs associated with the MAC entity, wherein the second control signaling further indicates a value of a plurality of values for a timer associated with the DSR for each of one or more LCHs of the group of LCHs, and wherein the second control signaling comprises a MAC-CE or DCI.
Aspect 27: The method of aspect 26, further comprising: receiving HARQ acknowledgment based at least in part on the transmitted second control signaling.
Aspect 28: The method of any of aspects 22 through 27, further comprising: receiving a report associated with a learning model, wherein the report is based at least in part on a reporting configuration, an event-based reporting trigger, or a prohibit timer.
Aspect 29: A wireless device for wireless communications, comprising one or more memories storing processor-executable code, and one or more processors coupled with the one or more memories and individually or collectively operable to execute the code to cause the wireless device to perform a method of any of aspects 1 through 21.
Aspect 30: A wireless device for wireless communications, comprising at least one means for performing a method of any of aspects 1 through 21.
Aspect 31: A non-transitory computer-readable medium storing code for wireless communications, the code comprising instructions executable by one or more processors to perform a method of any of aspects 1 through 21.
Aspect 32: A network entity for wireless communications, comprising one or more memories storing processor-executable code, and one or more processors coupled with the one or more memories and individually or collectively operable to execute the code to cause the network entity to perform a method of any of aspects 22 through 28.
Aspect 33: A network entity for wireless communications, comprising at least one means for performing a method of any of aspects 22 through 28.
Aspect 34: A non-transitory computer-readable medium storing code for wireless communications, the code comprising instructions executable by one or more processors to perform a method of any of aspects 22 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive control signaling that indicates a configuration comprising a first set of one or more parameters associated with delay status reporting for each of one or more logical channels of a group of logical channels associated with a medium access control entity of the wireless device, wherein at least one parameter of the first set of one or more parameters is associated with a plurality of values;
select a value of the plurality of values for a timer associated with the delay status reporting for each of one or more logical channels of the group of logical channels based at least in part on a second set of one or more parameters; and
process one or more service data units for each of one or more logical channels of the group of logical channels according to the selected value of the plurality of values for the timer associated with the delay status reporting.

2. The wireless device of claim 1, wherein:
the first set of one or more parameters comprises an input to a learning model associated with the delay status reporting for each of one or more logical channels of the group of logical channels associated with the medium access control entity,
the second set of one or more parameters comprises an output of the learning model associated with the delay status reporting for each of one or more logical channels of the group of logical channels associated with the medium access control entity, and
the value of the plurality of values for the timer associated with the delay status reporting is selected based at least in part on the input to the learning model and the output of the learning model.

3. The wireless device of claim 1, wherein at least one parameter of the first set of one or more parameters comprises an indication to enable or disable a learning model associated with the delay status reporting for each of one or more logical channels of the group of logical channels.

4. The wireless device of claim 1, wherein:
one or more parameters of the first set of one or more parameters comprises a lower boundary value for the timer associated with the delay status reporting for each of one or more logical channels of the group of logical channels or an upper boundary value for the timer associated with the delay status reporting for each of one or more logical channels of the group of logical channels, or
the one or more parameters of the first set of one or more parameters comprises a range of values for the timer associated with the delay status reporting for each of one or more logical channels of the group of logical channels.

5. The wireless device of claim 1, wherein one or more parameters of the first set of one or more parameters comprises:
a first indication that the medium access control entity is allowed to override a default value for the timer associated with the delay status reporting for each of one or more logical channels of the group of logical channels, and
a second indication that the medium access control entity is prohibited to override the default value for the timer associated with the delay status reporting for each of one or more logical channels of the group of logical channels, or
a second indication that the medium access control entity is allowed to override the default value of the timer associated with the delay status reporting for each of one or more logical channels of the group of logical channels based at least in part on a condition.

6. The wireless device of claim 1, wherein the one or more processors are individually or collectively further operable to execute the code to cause the wireless device to:
transmit an indication of the selected value of the plurality of values for the timer associated with the delay status reporting for each of one or more logical channels of the group of logical channels,
wherein the indication comprises a medium access control-control element (MAC-CE) or an uplink control information (UCI).

7. The wireless device of claim 6, wherein the indication of the selected value of the plurality of values for the timer associated with the delay status reporting for each of one or more logical channels of the group of logical channels is transmitted based at least in part on a periodicity or a condition.

8. The wireless device of claim 6, wherein the indication of the selected value of the plurality of values for the timer associated with the delay status reporting for each of one or more logical channels of the group of logical channels is transmitted based at least in part on a prohibit timer.

9. The wireless device of claim 1, wherein the configuration comprises a radio resource control (RRC) configuration.

10. The wireless device of claim 1, wherein the one or more processors are individually or collectively further operable to execute the code to cause the wireless device to:
receive second control signaling that indicates a logical channel identifier,
wherein the logical channel identifier maps to one or more logical channels of the group of logical channels associated with the medium access control entity,
wherein the second control signaling further indicates the value of the plurality of values for the timer associated with the delay status reporting for each of one or more logical channels of the group of logical channels,
wherein the second control signaling comprises a medium access control-control element (MAC-CE) or downlink control information (DCI), and
wherein selecting the value of the plurality of values for the timer associated with the delay status reporting is based at least in part on the received second control signaling.

11. The wireless device of claim 10, wherein the one or more processors are individually or collectively further operable to execute the code to cause the wireless device to:
transmit a hybrid automatic repeat request (HARQ) acknowledgment based at least in part on the received second control signaling.

12. The wireless device of claim 1, wherein the one or more processors are individually or collectively further operable to execute the code to cause the wireless device to:
generate a report associated with a learning model, wherein the report comprises a set of one or more logs associated with processing of the one or more service data units according to the learning model and one or more selected values of the plurality of values for the timer associated with the delay status reporting for each of one or more logical channels of the group of logical channels; and
transmit the report associated with the learning model to a network entity or a second wireless device.

13. The wireless device of claim 12, wherein the report is based at least in part on a reporting configuration, an event-based reporting trigger, or a prohibit timer.

14. The wireless device of claim 1, wherein the one or more processors are individually or collectively further operable to execute the code to cause the wireless device to:
transmit, to a network entity or a second wireless device, a report comprising capability information that indicates whether the wireless device supports a learning model associated with the delay status reporting for each of one or more logical channels of the group of logical channels associated with the medium access control entity,
wherein the capability information further indicates whether the wireless device supports performance reporting for the learning model associated with the delay status reporting for each of one or more logical channels of the group of logical channels associated with the medium access control entity,
wherein the control signaling that indicates the configuration is received based at least in part on the capability information.

15. The wireless device of claim 1, wherein at least one parameter of the first set of one or more parameters comprises a minimum value for the timer associated with the delay status reporting for each of one or more logical channels of the group of logical channels.

16. The wireless device of claim 1, wherein at least one parameter of the first set of one or more parameters comprises a maximum value for the timer associated with the delay status reporting for each of one or more logical channels of the group of logical channels.

17. The wireless device of claim 1, wherein at least one parameter of the first set of one or more parameters comprises an indication to override a current value of the timer associated with the delay status reporting for each of one or more logical channels of the group of logical channels by the selected value.

18. The wireless device of claim 1, wherein at least one parameter of the first set of one or more parameters comprises an indication of a threshold value to be satisfied prior to an override of a current value of the timer associated with the delay status reporting for each of one or more logical channels of the group of logical channels by the selected value.

19. The wireless device of claim 1, wherein at least one parameter of the first set of one or more parameters comprises an indication for reporting the timer associated with the delay status reporting for each of one or more logical channels of the group of logical channels.

20. The wireless device of claim 1, wherein at least one parameter of the first set of one or more parameters comprises a duration for periodic reporting of the timer associated with the delay status reporting for each of one or more logical channels of the group of logical channels.

21. The wireless device of claim 1, wherein at least one parameter of the first set of one or more parameters comprises a duration for event-based reporting of the timer associated with the delay status reporting for each of one or more logical channels of the group of logical channels.

22. A network entity, comprising:
one or more memories storing processor-executable code; and
one or more processors coupled with the one or more memories and individually or collectively operable to execute the code to cause the network entity to:
transmit control signaling that indicates a configuration comprising a first set of one or more parameters associated with delay status reporting for each of one or more logical channels of a group of logical channels associated with a medium access control entity of a wireless device, wherein at least one parameter of the first set of one or more parameters is associated with a plurality of values; and
receive one or more service data units for each of one or more logical channels of the group of logical channels.

23. The network entity of claim 22, wherein at least one parameter of the first set of one or more parameters comprises an indication to enable or disable a learning model associated with the delay status reporting for each of one or more logical channels of the group of logical channels.

24. The network entity of claim 22, wherein the one or more processors are individually or collectively further operable to execute the code to cause the network entity to:
receive an indication of a selected value of a plurality of values for a timer associated with the delay status reporting for each of one or more logical channels of the group of logical channels, wherein the indication comprises a medium access control-control element (MAC-CE) or uplink control information (UCI).

25. The network entity of claim 22, wherein the configuration comprises a radio resource control (RRC) configuration.

26. The network entity of claim 22, wherein the one or more processors are individually or collectively further operable to execute the code to cause the network entity to:
transmit second control signaling that indicates a logical channel identifier,
wherein the logical channel identifier maps to one or more logical channels of the group of logical channels associated with the medium access control entity of the wireless device,
wherein the second control signaling further indicates a value of a plurality of values for a timer associated with the delay status reporting for each of one or more logical channels of the group of logical channels, and
wherein the second control signaling comprises medium access control-control element (MAC-CE) or downlink control information (DCI).

27. The network entity of claim 26, wherein the one or more processors are individually or collectively further operable to execute the code to cause the network entity to:
receive hybrid automatic repeat request (HARQ) acknowledgment based at least in part on the transmitted second control signaling.

28. The network entity of claim 22, wherein the one or more processors are individually or collectively further operable to execute the code to cause the network entity to:
receive a report associated with a learning model, wherein the report is based at least in part on a reporting configuration, an event-based reporting trigger, or a prohibit timer.

29. A method for wireless communications at a wireless device, comprising:
receiving control signaling that indicates a configuration comprising a first set of one or more parameters associated with delay status reporting for each of one or more logical channels of a group of logical channels associated with a medium access control entity of the wireless device, wherein at least one parameter of the first set of one or more parameters is associated with a plurality of values;
selecting a value of the plurality of values for a timer associated with the delay status reporting for each of one or more logical channels of the group of logical channels based at least in part on a second set of one or more parameters; and
processing one or more service data units for each of one or more logical channels of the group of logical channels according to the selected value of the plurality of values for the timer associated with the delay status reporting.

30. A method for wireless communications at a network entity, comprising:
transmitting control signaling that indicates a configuration comprising a first set of one or more parameters associated with delay status reporting for each of one or more logical channels of a group of logical channels associated with a medium access control entity of a wireless device, wherein at least one parameter of the first set of one or more parameters is associated with a plurality of values; and
receiving one or more service data units for each of one or more logical channels of the group of logical channels.
